(19) United States
(12) Patent Application Publication
(10) Pub. No.: US 2007/0226402 A1
(43) Pub. Date: Sep. 27, 2007

(54) Data management and control system in semiconductor flush memory and semiconductor flush memory accommodation apparatus

(75) Inventors: Nobuaki Kohinata, Yokoyama (JP); Mika Mizutani, Tokyo (JP); Hermanto, Saitama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: HITACHI SYTSEMS & SERVICES, LTD., TOKYO (JP)

(21) Appl. No.: 11/603,115

(22) Filed: Nov. 22, 2006

(30) Foreign Application Priority Data
Mar. 7, 2006 (JP) 2006-061293

(51) Int. Cl. G06F 12/00

(52) U.S. Cl. 711/103

(57) ABSTRACT

Service life of a semiconductor flush memory is extended by averaging the number of times of rewrite operation and non-uniformity of time associated with a synchronization processing is eliminated. The invention provides a mapping rule such that when a space bitmap recorded to a semiconductor flush memory spreads over three erase blocks in the semiconductor flush memory using a UDF file system as a file system, a Root directory is recorded to partial DSA1 corresponding to partial SBM1, a first file directory group is recorded to only partial DSA1 and partial DSA2 corresponding to partial SBM1 and partial SBM2, and a second file directory group is recorded to only partial DSA1 and partial DSA3 corresponding to partial SBM1 and partial SBM3.

### INCORPORATION BY REFERENCE

The present application claims priority from Japanese application JP 2006-061293 filed on Mar. 7, 2006, the content of which is hereby incorporated by reference into this application.

### BACKGROUND OF THE INVENTION

1. Field of the Invention

This invention relates to a data management and control system in a semiconductor flush memory having its feature in data erasure in a block unit and to a semiconductor flush memory accommodation apparatus such as a monitor camera apparatus to which the semiconductor flush memory is applied, by way of example.

2. Description of the Related Art

Utilization of a semiconductor flush memory as a storage device having its feature in data erasure in a block unit has increased in recent years owing to the increase of its memory capacity and the decrease of its cost. To utilize such a semiconductor flush memory as the storage device, known features of the semiconductor flush memory must be taken into account.

First, each block has a predetermined number of times of rewrite guarantee and this is related with reliability of the semiconductor flush memory, that is, its service life as the memory. Therefore, each block must be used on an average lest the use of the block exceeds the number of times of rewrite guarantee.

Second, the semiconductor flush memory has another feature that an overwrite operation to the same block needs a longer time till completion than a mere write operation not involving overwrite because the block must be once erased. It is therefore necessary to arbitrate lest the overwrite operation competes with the read operation or the mere write operation or to decrease the overwrite operation itself.

To satisfy the first requirement, a long life system has been proposed that includes a rewrite number-of-times counter for counting the number of times of rewrite operations for each block of a semiconductor flush memory, records data on the basis of this counter value and averages the number of times of the rewrite operations (refer to JP-A-2004-310656, for example). To satisfy the second requirement, an overwrite operation reducing system is known that executes a synchronization processing by once copying to a system memory (main storage) those data which must be frequently updated on a semiconductor flush memory, changing the data so copied and writing back the data on the system memory to the semiconductor flush memory at a timing different from the timing of the change. A high speed system is further known that writes back in a block unit only the portion at which the change occurs when executing the synchronization processing described above to shorten the time necessary for the synchronization processing (refer to JP-A-2005-216119, for example).

Incidentally, a file system is necessary to record and manage data not only to a semiconductor flush memory but also a variety of media such as an optomagnetic disk and HDD (Hard Disk Drive). Various file systems are available depending on physical features of the media and their utilization form and provide functions of holding various data as management information such as a creation time of data afresh created, a modified time when existing data are edited, and kinds and attributes of data, and designating a sector and a page for recording the data to the media. This very management information in the file system is one of those data which must be frequently updated.

FAT (File Allocation Table) is available for the file system used in a large number of files and a UDF (Universal Disk Format) file system which is a de facto standard for the optomagnetic disks has drawn an increasing attention to secure compatibility that results from the increase of the capacity of the media and portability.

A data management method in a UDF file system specification will be hereby explained with reference to FIGS. 2 and 3. The explanation about FIGS. 2 and 3 is a technology as the premise of the data management and control system according to an embodiment of the invention. FIG. 2 shows a directory structure to which the file data recorded to a semiconductor flush memory belongs. As shown in the drawing, Dir1 (22), Dir2 (24) and File3 (23) exist immediately below a Root directory 21. File1 (25) and Dir3 (26) exist below the Dir1 (22) and File2 (27) exists below the Dir2 (24).

FIG. 3 shows an example where the directory structure shown in FIG. 2 is expressed by the UDF file system specification. As shown in the drawing, RootFE (File Entry) 31 includes header information and FID (File Identifier Description) to Dir1FE32, Dir2FE33 and File3FE34. The Dir1FE32 includes header information and FID to Dir3FE35, File1FE36 and RootFE31. The Dir2FE33 includes header information and FID to File2FE37 and RootFE31. File1FE36, File2FE37 and File3FE34 have header information and data of each file.

In the UDF file system specification, the directory and the file are managed by a data structure called “FE (File Entry)” and in the case of the directory, pointer information to its subordinate files and slave directories, or sub directories, and a pointer to a master directory, or a parent directory, are managed. Therefore, when File3FE34 is deleted, for example, predetermined bits of FID corresponding to this file3FE34 must be changed in RootFE31.

On the other hand, the application field of the semiconductor flush memory includes storage devices for PC (Personal Computers) primarily handling text data and digital camera apparatuses primarily handling still images and media for recording and preserving real time data such as images and music, and the semiconductor flush memory will be assembled into various apparatuses in future.

An example of the assembling apparatuses is a monitor camera apparatus. The monitor camera apparatus everyday acquires and records monitor information such as dynamic images and still images at an installation-position at a predetermined timing. From its application and object, the monitor camera apparatus must satisfy a small size, easy maintenance property, power saving property, silence, impact resistance, and so forth.

A monitor camera apparatus having HDD as recording means for storing the monitor information has been available in the past but it will be sufficiently possible to use the semiconductor flush memory in place of the HDD in view of the requirements described above. As described above so far, however, a data management and control system that takes the features of the semiconductor flush memory into account is necessary to record the data such as the monitor information for which the real time property is required, to the semiconductor flush memory.

According to the life extension system for the known features of the semiconductor flush memory as disclosed in JP-A-20004-310656, however, the counter value representing the number of times of the rewrite operations for each block (also called “erase block”) must be recorded to the semiconductor flush memory that is a nonvolatile medium.

During the normal operation, the counter value copied to the system memory (main storage), for example, is counted up but the counter value must be written back to a predetermined block of the semiconductor flush memory as a synchronization processing to cope with an accidental problem such as a power source failure. In consequence, the quantity of data to be written back at the time of the synchronization processing and the number of blocks increase with the result that the time required for the synchronization processing increases. (The objects to be synchronously processed in the system memory and the semiconductor flush memory include the count value of the rewrite operation and the data necessary for the rewrite operations).

According to the high speed system to cope with the known features of the semiconductor flush memory disclosed in JP-A-2005-216119, the number of positions changed on the system memory, that is, the number of blocks to be written back to the semiconductor flush memory in the synchronization processing, is not always constant. Therefore, there remains the problem that the time required for the synchronization processing irregularly changes.

### SUMMARY OF THE INVENTION

To solve the problems described above, the invention aims at providing a data management and control system that attains longer service life of a semiconductor flush memory by averaging its rewrite operations and can easily read and write real time data by solving non-uniformity of time related with a synchronization processing.

To accomplish the object described above, the invention mainly employs the following constructions.

Namely, the invention provides a data management and control system in a semiconductor flush memory for executing data erasure in a block unit, wherein a data storage area for storing file data based on a UDF file system specification and a space bitmap constituted by a plurality of partial space bitmaps in a block unit and representing the use condition of the data storage area are formed in the semiconductor flush memory, each of the partial space bitmaps corresponds to a partial data storage area divided in the data storage area, and a mapping rule for associating file directory groups so assorted as to correspond to the number of the partial space bitmaps and the partial data storage areas is set to provide partial data storage areas to which one file directory group cannot execute recording in such a fashion as to spread over.

When the number of the partial space bitmaps is N (N≧3) in the data management and control system of the semiconductor flush memory described above, the mapping rule has the construction such that it contains a root directory in the file data, divides file directories below the root directory into N file directory groups without causing the file directories below the root directory to overlap with one another, manages the root directory by the first partial space bitmap, manages an Mth (1<M<N) file directory group by the first and Mth partial space bitmaps, and records the Mth file directory group to only the first and Mth partial data storage areas.

When the partial space bitmaps is N (N≧2) in the data management and control system, the mapping rule has the construction such that it contains only once the root directory in the file data, divides the file directories below the root directory into N file directory groups without causing the file directories below the root directory to overlap with one another, manages the root directory by the first partial space bitmap, manages an Mth (1<M<N) file directory group by the Mth partial space bitmap, and records the Mth file directory group to only the Mth partial data storage areas.

According to the invention, there is provided the mapping rule that associates the directory structure to which data as the recording object belongs with the data storage area to which the data is recorded. Owing to this association of the mapping rule, the data storage area can be explicitly dispersed by taking the directory structure into account. In consequence, the number of times of the rewrite operations of the bitmap in the synchronization processing can be averaged and the number of times of the rewrite operations of the data storage area for recording the data corresponding to the space bitmap can be averaged, too. In other words, the service life of the semiconductor flush memory can be extended.

The invention can localize the change occurring in the entire space bitmap of the semiconductor flush memory. It becomes thus possible to shorten and make uniform the time required for the synchronization processing of the space bitmap and to guarantee the maximum time necessary for the synchronization processing. Therefore, it is possible to restrict the delay of the read operation of the data with the synchronization processing and the delay of the mere write operation and to easily accomplish read/write of data having high real time property from/to a semiconductor flush memory.

Furthermore, the recording site of the data in the data storage area can be limited. It is thus possible to prevent the data from being unnecessarily fragmented, to improve access performance to a desired file data and to shorten the retrieval time.

### BRIEF DESCRIPTION OF THE DRAWINGS

FIG. 1 is a view showing a directory structure for explaining a mapping rule applied to a data management and control system according to a first embodiment of the invention;

FIG. 2 is a view showing a directory structure to which file data recorded on a semiconductor flush memory belongs;

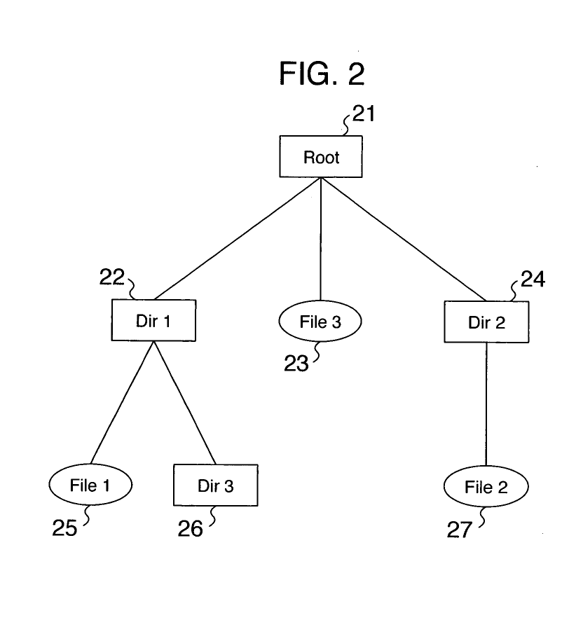

FIG. 3 is a view useful for explaining a file management method when the directory structure shown in FIG. 2 is expressed by a UDF file system specification;

FIG. 4 is a block diagram showing a construction of a semiconductor flush memory accommodation apparatus that uses the data management and control system according to the first embodiment of the invention;

FIG. 5 is a view useful for explaining the operation of the semiconductor flush memory accommodation apparatus according to the first embodiment of the invention;

FIG. 6 is a view useful for explaining a monitor camera apparatus as an application example of the semiconductor flush memory accommodation apparatus according to the first embodiment of the invention;

FIG. 7 is a view useful for explaining a directory structure when the mapping rule according to the first embodiment of the invention is applied to a monitor camera apparatus;

FIG. 8 is a view showing a directory structure for explaining a mapping rule according to a second embodiment of the invention; and

FIG. 9 is a view useful for explaining a directory structure when the mapping rule according to the second embodiment of the invention is applied to a monitor camera apparatus.

### DESCRIPTION OF THE EMBODIMENTS

### First Embodiment

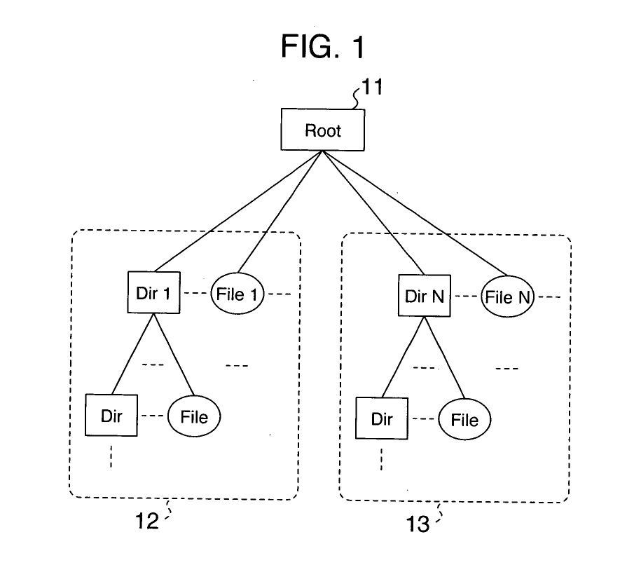

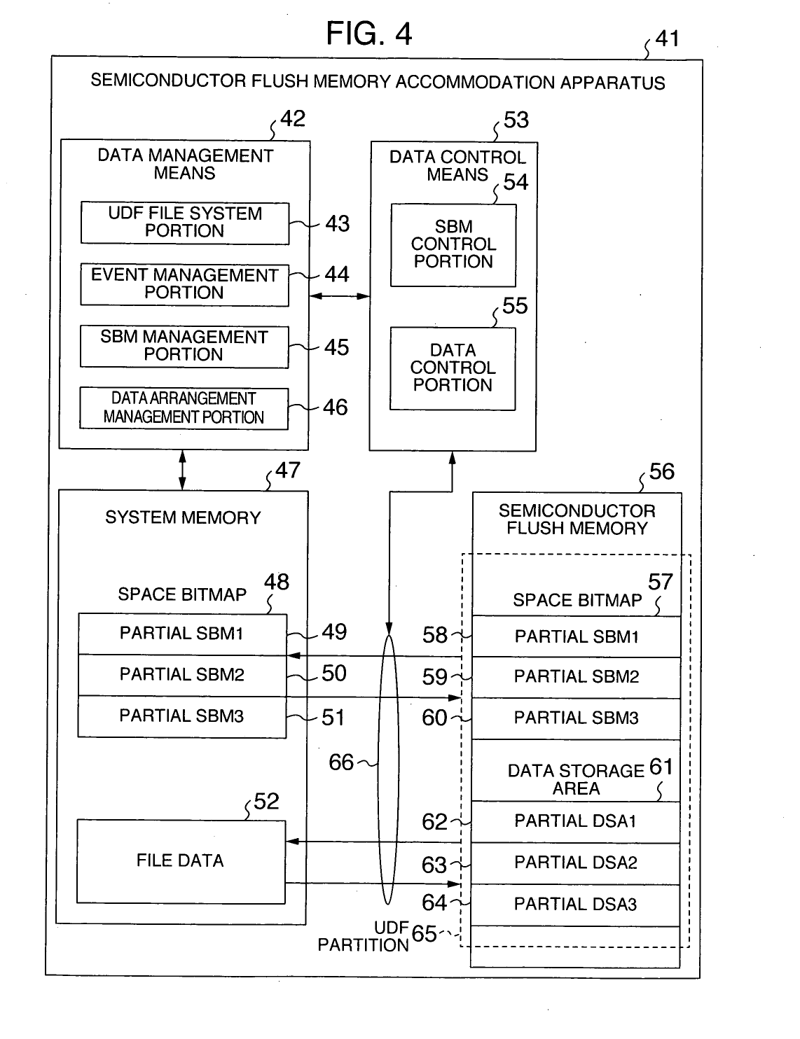

A semiconductor flush memory accommodation apparatus equipped with a data management and control system according to the first embodiment of the invention will be hereinafter explained with reference to FIGS. 1 and 4. FIG. 1 is a view showing a directory structure to which file data belongs, for explaining a mapping rule applied to the data management and control system according to the first embodiment of the invention. FIG. 4 is a block diagram showing a semiconductor flush memory accommodation apparatus equipped with the data management and control system according to the first embodiment of the invention.

Referring to FIG. 4, the semiconductor flush memory accommodation apparatus 41 includes data management means 42, data control means 53, a system memory 47 and a semiconductor flush memory 56. The semiconductor flush memory 56 is so constituted as to execute data erasure in a block unit. In the example shown in FIG. 4, as will be later explained, portions SBM1, SBM2 and SBM3 of the semiconductor flush memory are the data erasure block units, respectively, and each of the portions DSA1, DSA2 and DSA3 consists of a plurality of erasure block units.

The semiconductor flush memory 56 is formatted on the basis of a UDF file system specification and FIG. 4 illustrates a space bitmap 57 and a data storage area 61 in a UDF partition 65.

The space bitmap 57 is a bit map that is stipulated by the UDF file system specification managing the use condition (free condition) in the UDF partition 65 of the semiconductor flush memory 56 in a page unit (512-byte unit, for example). In other words, the space bitmap 57 represents the recording sites of various data stored in the semiconductor flush memory 56. FIG. 4 shows the example of the arrangement condition of the space bitmap 57 that continuously spreads over three blocks. Each space bitmap of the block unit so arranged as to spread over a plurality of blocks will be hereinafter called “partial SBM (Space Bitmap) 1 (58)”, “partial SBM2 (59)” and “partial SBM3 (60)”. Recording of the space bitmap 57 in such a manner as to spread over a plurality of blocks is the phenomenon that can generally occur with the recent increase of the capacity though it depends on the page size and the block size of the semiconductor flush memory 56 and further on the size of the UDF partition 65.

The data storage area 61 is the one to which the file data 52 on the system memory 47, etc, is recorded. The data storage areas 61 corresponding to the partial SBM1 (58), partial SBM2 (59) and partial SBM3 (60) of the space bitmap 57 will be hereinafter called “partial DSA (Data Sub Area) 1 (62)”, “partial DSA2 (63)” and “partial DSA3 (64)”, respectively.

The system memory 47 is the area for storing the space bitmap 48 as a copy of the space bitmap 57 described above or for temporarily storing various kinds of file data 52 generated by an application program edited by a user in order for the data management means 42 to look up or change at a high speed the space bitmap 57 of the semiconductor flush memory 56. The space bitmap 48 of the system memory 47 is read out from the semiconductor flush memory 56 in accordance with a predetermined actuation sequence at the start of the operation of the semiconductor flush memory accommodation apparatus 41 and is written back to the semiconductor flush memory 56 in accordance with a predetermined finish sequence at the end of the operation.

The space bitmap 48 is sequentially written back to the semiconductor flush memory 56 during the operation in accordance with the instruction of the event management portion 44 of the data management means 42, though the detail will be described later, and a synchronization processing is executed between the semiconductor flush memory 56 and the space bitmap 57. Incidentally, the synchronization processing between the flush memory 47 and the semiconductor flush memory 56 is directed to the file data 52 and the data of each DSA in the data storage area 62 besides the space bitmaps 48 and 57.

The data management means 42 includes a UDF file system portion 43, an event management portion 44, an SMB management portion 45 and a data arrangement management portion 46. The UDF file system portion 43 formats the semiconductor flush memory 56 by relying on the UDF file system specification and executes generation, manages, changes and looks up generation, updating data, attribute, etc, of the file data 52 and further manages the use condition (free condition) of the UDF partition 65 in the semiconductor flush memory 56 by using the space bitmap 48 on the system file memory 47. The UDF file system portion 43 notifies the arrangement condition of the space bitmap 57 decided at the time of formatting to the data arrangement management portion 46.

The SBM management portion 45 is the portion that provides necessary information when the synchronization processing of the space bitmap 48 of the system memory 47 and the space bitmap 57 of the semiconductor flush memory 56 is executed. The event management portion 44 receives the notice from each functional portion constituting the data management portion 42 and the data control portion 53, and, though not shown in FIG. 4, receives notices from a timer unit and so on included within the flush memory accommodation apparatus 41 and generates the instruction corresponding to the notice to each functional portion. The event management portion 44 also executes scheduling of the execution of the synchronization processing.

The data arrangement management portion 46 is the portion that provides a mapping rule for deciding to the partial DSA corresponding to which SBM of the semiconductor flush memory 56 the partial the file data 52 on the system memory 47 is to be recorded in accordance with the arrangement condition of the space bitmap 57 in the semiconductor flush memory 56 acquired from the UDF file system portion 43, that is, a mapping rule for associating the directory structure of the file data 52 with the partial DSA1 (62), the partial DSA2 (63) and the partial DSA3 (64) of the space bitmap 57.

The data management means 42 described above can be accomplished as a software, for example, as an OS (Operating System) that controls and manages the semiconductor flush memory accommodation apparatus 41, or as an extension function of the UDF file system portion 43.

The data control means 53 includes an SBM control portion 54 and a data control portion 55. The SBM control portion 54 and the data control portion 55 control various kinds of data flows 66 between the system memory 47 and the semiconductor flush memory 56. The data control means 53 can be accomplished as control software in hardware that provides a physical interface to the semiconductor flush memory 56.

Next, the data arrangement management portion 46 of the data management means 42 will be explained with reference to FIGS. 4 and 1. FIG. 1 shows the case where the space bitmap 57 in the semiconductor flush memory 56 spreads over three blocks as shown in FIG. 4. The drawing represents the directory structure to which the file data 52 on the system memory 47 recorded to the data storage area 61 of the semiconductor flush memory 56 belongs.

In the first embodiment of the invention, a Root directory 11 shown in FIG. 1 is recorded to the partial DSA1 (62) of the data storage area 61 corresponding to the partial SBM1 (58) shown in FIG. 4, a first file directory group 12 arranged under the Root directory 11 is recorded to the partial DSA1 (62) and the partial DSA2 (63) corresponding to the partial SBM1 (58) and the partial SBM2 (59) shown in FIG. 4 and a second file directory group 13 arranged under the Root directory 11 is recorded to the partial DSA1 (62) and the partial DSA3 (64) respectively corresponding to the partials SBM1 (58) and SBM3 (60) shown in FIG. 4. Furthermore, the first file directory group 12 and the second file directory group 13 cannot be recorded in such a fashion as to spread over the partial DSA2 (63) and the partial DSA3 (64) corresponding to the partial SBM2 (59) and the partial SBM3 (60) shown in FIG. 4. This mapping rule is one of the features of the first embodiment of the invention.

Incidentally, it is also possible to set a file directory group of a low hierarchy, or a deep hierarchy, to DSA2 and a file directory group of a high hierarchy, or a shallow hierarchy, to DSA1 in consideration of the updating frequency and to change them in accordance with the use condition. In short, a primary object is to uniformly use the blocks of the flush memory (erase blocks as the unit of erasing). When File 1 of the first file directory group is to be rewritten in the example shown in FIG. 1, the route direction remains quite naturally unaltered.

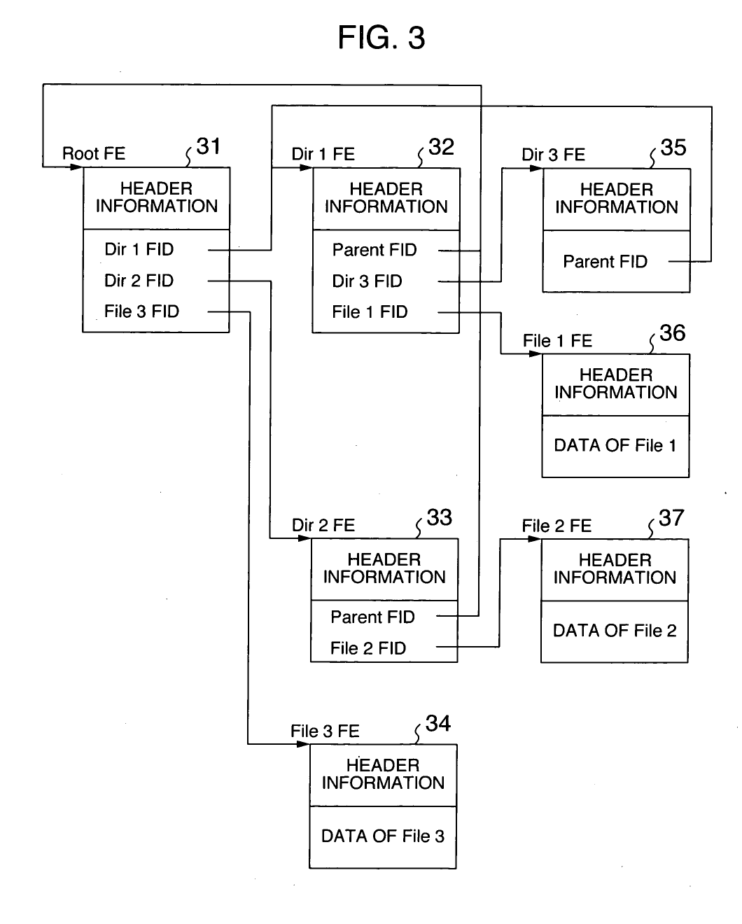

In the data structure (FE) for managing the directory and the file, the UDF file system specification includes pointer information to files and sub directories as the subordinates and pointers to the parent directory as shown in FIG. 3. Therefore, the mapping rule described above that records the first file directory group 12 shown in FIG. 1 in such a fashion as to spread over the portion DSA1 (62) and the portion DSA2 (63) respectively corresponding to the partial SBM1 (58) and the partial SBM2 (59) shown in FIG. 4 is directed to provide freedom to the file and the directory structure immediately below the Root directory 11 in the first file directory group 12.

Similarly, the mapping rule that permits recording of the second file directory group 13 in such a fashion as to spread over the partial DSA1 (62) and the partial DSA3 (64) respectively corresponding to the partial SBM1 (58) and the partial SBM3 (60) is directed to provide freedom to the file and directory structure immediately below the Root directory 11 in the second file directory group 13.

Incidentally, the data is erased in the block unit in the space bitmap and the data storage area of the semiconductor flush memory 56 as described above. Each partial SBM of the space bitmap corresponds to the block unit to be erased and each partial DSA is the portion which is constituted by a plurality of erase block units and to which the file data 52 is to be recorded. The number of partial SBM in the space bitmap is determined depending on the size and attribute of the semiconductor flush memory and the partial SBM and the partial DSA of the semiconductor flush memory correspond to one another. In this embodiment, the directory structure shown in FIG. 1 is assorted as the file directory groups in such a fashion as to correspond to the number of the partial SBM. Here, the mapping rule decides to which part of the partial DSA (62, 63, 64) shown in FIG. 4 the file directory group assorted as shown in FIG. 1 is to be recorded. This embodiment creates the mapping rule stipulating that one file directory group cannot be recorded in such a fashion as to spread over specific partial DSA (between DSA2 and DSA3, for example).

The following effects can be acquired by employing the mapping rule that associates the directory structure of the file data 52 with each partial DSA of the data storage area 61 as described above. First, when the measure that alternately (time-wise) records the data for the first file directory group 12 and the second file directory group 13 shown in FIG. 1 from the short or long term viewpoint, the number of times of the rewrite operations of each partial SBM of the space bitmap for the synchronous processing can be averaged. In consequence, the number of times of the rewrite operation of the partial DSA for actually recording the file data can be averaged, too. (Each partial DSA is the portion which corresponds to each partial SBM and to which the file data 52 is recorded). Therefore, the service life of the semiconductor flush memory can be improved. Incidentally, the partial SBM corresponds to the erase block unit and the partial DSA is constituted by a large number of erase blocks.

The change does not occur in all of the three partial SBM when an operation such as change, deletion and addition occurs in one file or directory existing in the first or second file directory group 12 or 13 and the change can be limited to the maximum two partial SBM. Therefore, because the synchronization processing of the space bitmap can be quickly finished (or in other words, because the change can be limited to the two partial SBM at maximum in comparison with the case where the change occurs in all of the three partial SBM), the delay of the read operation and the write operation of the file data with the synchronization processing can be reduced. The maximum time for the synchronization processing can be estimated and write of the file data having the high real time property to the semiconductor flush memory and read from the semiconductor flush memory can be easily designed.

Furthermore, recording of the first file directory group 12 or the second file directory group 13 in such a fashion as to spread over specific partial SBM, that is, partial DSA, is inhibited (mapping rule stipulating that recording is not so made as to spread over DSA2 and DSA3 in the case of the example). Consequently, it becomes possible to prevent the file data and the directory structure in the semiconductor flush memory from being arranged in a complex manner or from being fragmented. The access performance can be thus improved to a desired file data and the retrieval time can be shortened.

Incidentally, FIG. 1 explains the mapping rule about the case where the space bitmap 57 is recorded in such a fashion as to spread over three blocks as shown in FIG. 4 but the mapping rule can be applied to the case where it is recorded in such a fashion as to spread over four or more blocks and a similar effect can be acquired. When the space bitmap in the semiconductor flush memory is arranged in such a fashion as to spread over four blocks, for example, four partial SBM exist at this time (partial SBM 1 to 4) and four partial DSA (partial DSA 1 to 4) corresponding to them also exist.

The mapping rule is set in the following way. The Root directory portion is recorded to the partial DSA1 corresponding to the partial SBM1, the first file directory group arranged below the Root directory is recorded to the partial DSA1 and the partial DSA2 corresponding to the partial SBM1 and the partial SBM2, the second file directory group arranged below the Root directory is recorded to the partial DSA1, the partial DSA3 corresponding to the partial SBM1 and the partial SBM3 and the third file directory group arranged below the Root directory is recorded to the partial DSA1 and the partial DSA4 corresponding to the partial SBM1 and the partial SBM4, and recording of each of the first file directory, the second file directory and the third file directory in such a fashion as to spread over the partial DSA corresponding to other SBM is not permitted. In this way, the change does not simultaneously occur in all the four partial SBM and the change position can be limited to maximum two partial SBM and partial DSA.

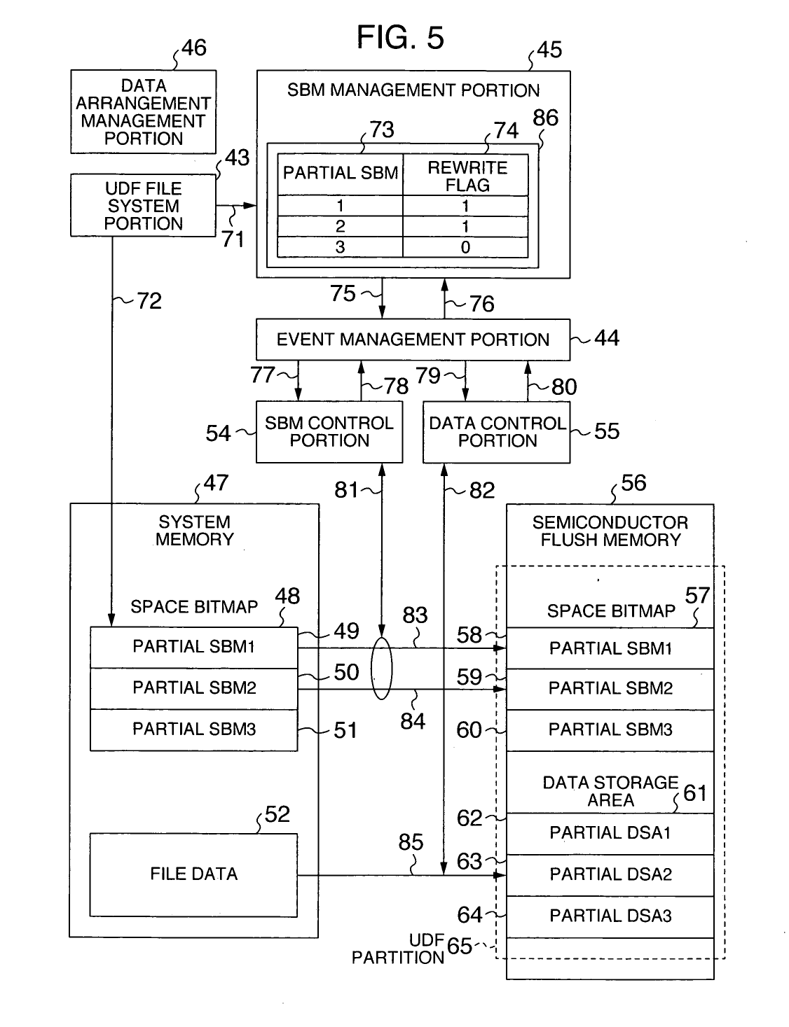

Next, the operations of the UDF file system portion 43, the SBM management portion 45, the event management portion 44, the SBM control portion 54 and the data control portion 55 will be explained with reference to FIG. 5 about the synchronization processing between the space bitmap 48 of the system memory 47 and the space bitmap 57 of the semiconductor flush memory 56 and the storage processing of the file data 52 of the system memory 47 into the data storage area 61 of the semiconductor flush memory 56 by way of example. Incidentally, FIG. 5 shows only those portions of the semiconductor flush memory accommodation apparatus 41 shown in FIG. 4 which are necessary for the explanation and are extracted with some parts being shown in further detail.

When the file data 52 on the system memory 47 is stored in the data storage area 61 of the semiconductor flush memory 56, the UDF file system portion 43 first looks up the space bitmap 48 of the system memory 47 and searches the recording position of the file data 52 in the semiconductor flush memory 56 in accordance with the mapping rule provided by the data arrangement management portion 46. When the recording position is decided, the space bitmap change processing 72 is executed to change the bit of any of the partial SBM1 (49) or the partial SBM2 (50) or the partial SBM3 (51) or the partial SBM1 (49) and the partial SBM2 (50) or the partial SBM1 (49) and the partialSBM3 (51) of the space bitmap 48 into the recording state. When the space bitmap change processing 72 is completed, the space bitmap updating completion notice 71 inclusive of the number of the partial SBM changed is generated to the SBM management portion 45.

Next, the SBM management portion 45 has an SBM management table 86 including a partial SBM number 73 and a rewrite flag 74 corresponding to the former. Receiving the space bitmap updating completion notice 71 described above, the SBM management portion 45 sets the rewrite flag 74 of the corresponding SBM management table 86 to 1. FIG. 5 shows the case where the partial SBM1 (49) and the partial SBM2 (50) of the space bitmap 48 are changed. When setting is complete, the flag set completion notice 75 is generated to the event management portion 44.

When receiving the flag set completion notice 75, the event management portion 44 generates a synchronization processing start instruction 77 of the space bitmap 48 to the SBM control portion 54. However, the event management portion 44 can acquire time information from the timer device, not shown in FIG. 5, and can execute scheduling that generates the synchronization processing start instruction 77 on the basis of time information from the timer device provided that it can know from predetermined separate means that the change occurs only in the partial SBM1 (49) and the partial SBM2 (50) for a certain predetermined time.

When receiving the synchronization processing start command 77, the SBM control portion 54 looks up the SBM management table 86 of the SBM management portion 45 and acquires the partial SBM as the object to be written back to the semiconductor flush memory 56. A series of rewrite processing 81 is carried out to write back the space bitmap data 83 of the partial SBM1 (49) and the space bitmap data 84 of the partial SBM2 (50) to the partial SBM1 (58) and the partial SBM2 (59) of the space bitmap 57 of the semiconductor flush memory 56 and to detect completion of this operation.

Here, the rewrite processing 81 is executed by a predetermined method by asking the rewrite operation of the partial SBM1 (49) and the partial SBM2 (50) to hardware providing a physical interface with the system memory 47 and the semiconductor flush memory 56, though the hardware is not shown in FIG. 5. This hardware reports completion of the rewrite operation to the SBM control portion 54 and the SBM control portion 54 acquires this notice. When the rewrite processing 81 is completed, the SBM control portion 54 generates the synchronization processing completion notice 78 to the event management portion 44.

When receiving this synchronization processing completion notice 78, the event management portion 44 generates a data storage instruction 79 for recording the file data 52 of the semiconductor flush memory 56 to the data control portion 55. At the same time, the event management portion 44 generates a flag clear instruction 76 for clearing the rewrite flag 74 of the SBM management table 86 to the SBM management portion 45. When receiving the flag clear instruction 76, the SBM management portion 45 clears all the rewrite flags 74 of the SBM management table 86 to 0.

When receiving the data storage instruction 79, the data control portion 55 executes a series of data storage processing 82 that stores the file data 52 in the partial DSA1 (62) and the partial DSA2 (63) in the data storage area 61 of the semiconductor flush memory 56 and detects completion of this storage operation.

The practical data storage processing 82 is executed by a similar mechanism to that of the rewrite processing 81 to the SBM control portion 54. In other words, recording of the file data 52 is requested to the hardware providing the physical interface between the system memory 47 and the semiconductor flush memory 56 and the write data 85 is recorded to the data storage area 61 by a predetermined method. The hardware described above notifies completion of the data recording to the data control portion 55 and the data control portion 55 acquires this notice. When the data storage processing 82 is completed, the data control portion 55 generates a data storage completion notice 80 to the event management portion 44.

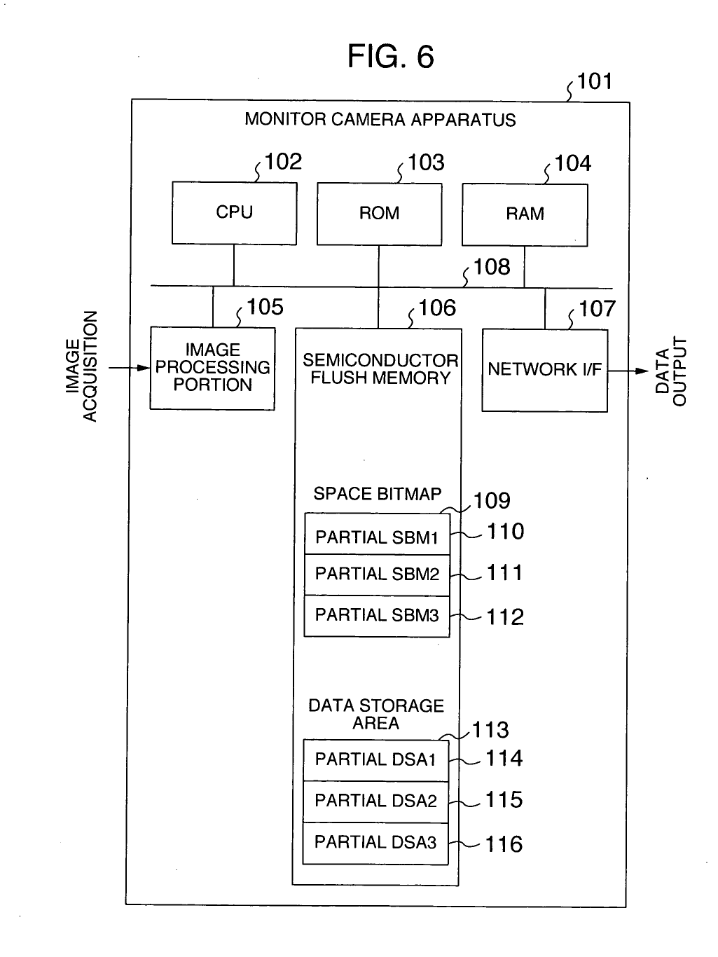

Next, a concrete semiconductor flush memory accommodation apparatus to which the data management and control system according to the first embodiment of the invention is applied will be explained with reference to FIG. 6. FIG. 6 shows a concrete example of the semiconductor flush memory accommodation apparatus 41 shown in FIG. 4 and has its feature in data erasure in the block unit. The drawing illustrates a monitor camera apparatus 101 that includes a semiconductor flush memory 106 formatted in the UDF file system specification, a CPU 102 constituting the data management means 42 and the data control means 53 in FIG. 4, an ROM 103 and an RAM 104 constituting a system memory 47, and furthermore, an image processing portion 105 and a network I/F (interface) 107.

The CPU 102 is mainly constituted by a microprocessor, executes various kinds of processing in accordance with OS and software programs stored in the ROM 103 and the RAM 104 and provides a physical interface with the semiconductor flush memory 106.

The ROM 103 and the RAM 104 are used as memories that store the software program executed by the CPU 102 and the software program providing the data management and control system according to the invention and temporarily store monitor information outputted from a space bitmap 109 located in the semiconductor flush memory 106, or from an image processing portion 105. The image processing portion 105 acquires analog image signals and analog sound signals, converts them to digital signals and executes a compression processing, whenever necessary. The image processing portion 105 outputs the digitized monitor information to a bus 108.

The semiconductor flush memory 106 is formatted in accordance with the UDF file system specification and stores the digitized monitor information in the space bitmap 109 and the data storage area 113. The monitor camera apparatus 101 shown in FIG. 6 acquires day by day dynamic images and still images in a predetermined interval and records the information into the semiconductor flush memory 106 so that the monitor information for at least one week is held.

A network I/F 107 is for establishing the connection with a wired or wireless network in order to transmit the digital data recorded to the semiconductor flush memory 106 to the outside of the monitor camera apparatus 101. Incidentally, the CPU 102, the ROM 103, the RAM 104, the image processing portion 105, the semiconductor flush memory 106 and the network I/F 107 are connected to one another through a bus 108 and can exchange necessary control information and data.

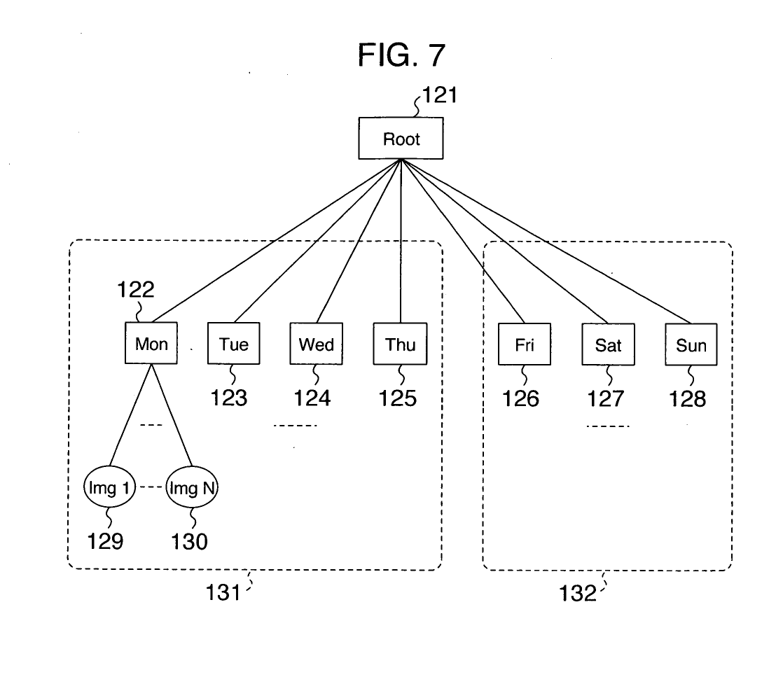

A directory structure for managing the dynamic images and the still images acquired by the monitor camera apparatus 101 shown in FIG. 6 and the recording method to the semiconductor flush memory 106 will be explained in accordance with the mapping rule of the first embodiment of the invention with reference to FIGS. 6 and 7. Incidentally, the drawings show the case where the space bitmap 109 disposed in the semiconductor flash memory 106 of the monitor camera apparatus 101 is so arranged as to spread over three blocks.

Weekday directories, that is, a Mon directory 122, a Tue directory 123, a Wed directory 124 and a Thu directory 125 are arranged as a first file directory group 131 below the Root directory 121 and remaining weekday directories, that is, a Fri directory 126, a Sat directory and a Sun directory 128 are disposed as the second file directory group 132. When the day of the week is Monday, for example, the dynamic images and the still images (Img1 (129) and ImgN (130)) acquired are serially stored in the Mon directory 122, and so forth.

The Root directory 121 is recorded to the partial DSA1 (114) corresponding to the partial SBM1 (110) shown in FIG. 6 and the first file directory group 131 is recorded to the partial DSA1 (114) and the partial DSA2 (115) corresponding to the partial SBM1 (110) and the partial SBM2 (111) shown in FIG. 6. The second file directory group 132 is recorded to the partial DSA1 (114) and the partial DSA3 (116) corresponding to the partial SBM1 (110) and the partial SBM3 (112) shown in FIG. 6. Recording of the first file directory group 131 and the second file directory group 132 in such a fashion as to spread over the partial DSA2 (115) and the partial DSA3 (116) corresponding to the partial SBM2 (111) and the partial SBM3 (116) shown in FIG. 6 is not permitted. Recording of the directory structure shown in FIG. 7 to the space bitmap and the data storage area of the semiconductor flush memory 106 in the manner described above is the mapping rule referred to in the first embodiment of the invention.

As described above, the monitor camera apparatus 101 of FIG. 6 to which the data management and control system according to the first embodiment of the invention is applied can dispersedly record the acquired monitor information in the month unit or the year unit into the semiconductor flush memory 106 and can therefore use on an average the blocks in which the space bitmaps are arranged. It is thus possible to extend the service life of the semiconductor flush memory and to save maintenance of the monitor camera apparatus 101.

Because the change position of the blocks in the space bit memory 109 can be limited to maximum two partial SBM, synchronization processing associated with the space bitmap 109 can be rapidly completed, and the maximum time associated with the synchronization processing can be estimated. In consequence, it is possible to write the acquired monitor information at a constant bit rate to the semiconductor flush memory 103 and to execute readout at a predetermined bit rate in accordance with the request from the network I/F 107. It is also possible to estimate the capacity of the RAM 104 and a temporary storage capacity that must be secured in the RAM 104 and to more easily design the monitor camera apparatus 101.

The monitor information acquired from Monday to Thursday is recorded to the partial DSA1 (114) and the partial DSA2 (115) corresponding to the partial SBM1 (110) and the partial SBM2 (111) and the data of the dynamic images and the still images acquired from Friday to Sunday is recorded to the partial DSA1 (114) and the partial DSA3 (116) corresponding to the partial SBM1 (110) and the partial SBM3 (112). In consequence, the access to the desired monitor information can be made at a high speed. The monitor camera apparatus has thus been explained as a concrete example of the semiconductor flush memory accommodation apparatus to which the data management and control system according to the first embodiment of the invention is applied.

### Second Embodiment

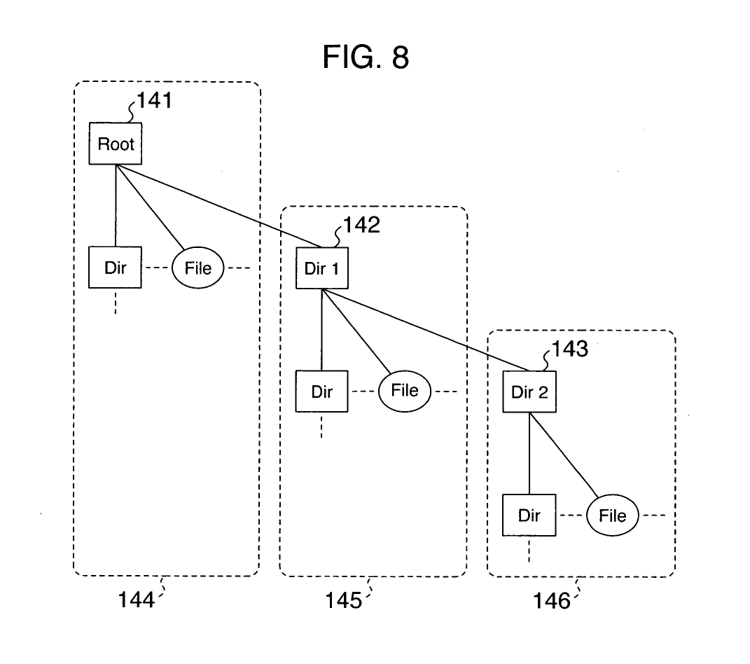

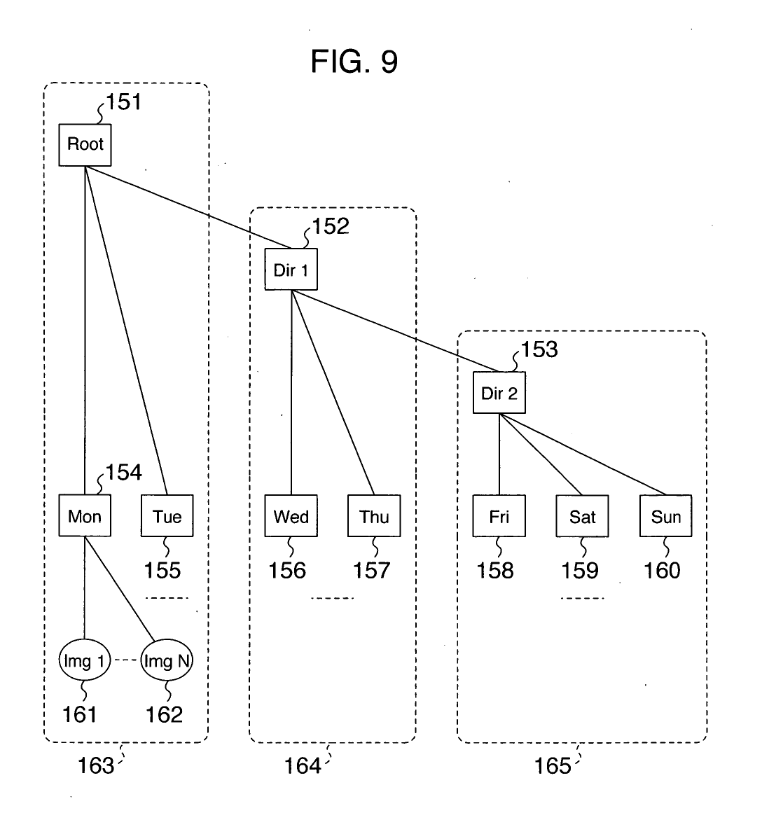

A data management method and a control system according to the second embodiment of the invention will be explained with reference to FIGS. 8 and 9.

FIG. 8 shows the case where the space bitmap 57 in the semiconductor flush memory 56 shown in FIG. 4 is so arranged as to spread over three blocks. The drawing shows a directory structure to which the file data 52 on the system memory 47 recorded to the data storage area 61 of the semiconductor flush memory 56 belongs.

With reference to the semiconductor flush memory accommodation apparatus 41 shown in FIG. 4, the first file directory group 144 inclusive of the Root directory 141 is recorded to the partial DSA1 (62) corresponding to the partial SBM1 (58) shown in FIG. 4 in the second embodiment of the invention provided by the data arrangement management portion 46 of the data management means 42. The second directory group 145 arranged below the Root directory 141 and including a certain Dir1 (142) is recorded to the partial DSA2 (63) corresponding to the SBM2 (59) shown in FIG. 4 and the third directory group 146 arranged below the Dir1 (142) and including a certain Dir2 (143) is recorded to the partial DSA3 (64) corresponding to the SBM3 (6b) shown in FIG. 4.

In addition, the following mapping rule is provided. Namely, the first file directory group 144 does not permit recording of the data to the partial DSA2 (63) and the partial DSA3 (64) corresponding to the partial SBM2 (59) and the partial SBM3 (60) shown in FIG. 4, the second file directory group 145 does not permit recording to the partial DSA1 (62) and the partial DSA3 (64) corresponding to the partial SBM1 (58) and the partial SBM3 (60) shown in FIG. 4, and the recording of the file directory group 146 to the partial DSA1 (62) and the partial DSA2 (63) corresponding to the partial SBM1 (58) and the partial SBM2 (59), shown in FIG. 4, are not permitted.

To achieve the mapping rule described above in accordance with the UDF file system specification, however, Dir1 (142) in the second file directory group 145 and Dir2 (143) in the third file directory group (146) cannot be deleted.

The second embodiment of the invention provides the following effects by employing the mapping rule described above. First, the data is recorded to the first file directory group 144, the second file directory group 145 and the third file directory group 146 shown in FIG. 8 in a predetermined sequence from the short-term or long-term viewpoint and in this way, the second embodiment can average the number of times of rewrite operations of each partial SBM of the space bitmap for the synchronization processing much more than the mapping rule of the first embodiment. In consequence, the number of times of rewrite operations of the partial DSA to which the file data is practically recorded can be averaged, too. Therefore, the service life of the semiconductor flush memory can be improved.

Any change, deletion or addition that occurs in one file or directory existing in the first file directory group 144 or in the second file directory group 145 or in the third file directory group 146 does not result in the occurrence of the change in all the three partial SBM and the change position can always be limited to one partial SBM. Therefore, the synchronization processing of the space bitmap can be completed more quickly than the mapping rule according to the first embodiment of the invention and the delay time of the read operation and the write operation of the file data with the synchronization processing can be further shortened. The time required for the synchronization processing can be fixed and read/write of the file data having high real time property to and from the semiconductor flush memory can be easily designed.

Since recording is made to only one partial SBM and to the partial DSA corresponding to the former in the first file directory group 144, the second file directory group 145 and the third file directory group 146, it is possible to prevent the file data and the directory structure on the semiconductor flush memory from being arranged more complexly and being more fragmented than the mapping rule according to the first embodiment of the invention. For this reason, the access performance to the desired file data can be improved and the retrieval time can be shortened.

The mapping rule according to the first embodiment of the invention can be applied to the case where the space bitmaps are arranged in at least three blocks whereas the mapping rule according to the second embodiment can be applied to the case where the space bitmap is arranged in two blocks. Therefore, the application range is broader.

Next, the directory structure for managing the dynamic images and the still images the monitor camera apparatus 101 shown in FIG. 6 acquires and a recording method to the semiconductor flush memory 106 will be explained in accordance with the mapping rule according to the second embodiment and with reference to FIGS. 6 and 9. Incidentally, this example represents the case where the space bitmap 109 in the semiconductor flush memory 106 of the monitor camera apparatus 101 is so arranged as to spread over three bocks as shown in FIG. 6.

In the directory structure shown in FIG. 9, a Root directory 151 and Mon directory 154 and a Tue directory 155 as weekday directories are disposed as a first file directory group 163, Dir1 (152) and a Wed directory 156 and a Thu directory as weekday directories are disposed as the second file directory group 164, a Fri directory 158, a Sat directory 159 and a Sun directory 160 as remaining weekday directories are disposed as the third file directory group 165. When the day of the week is Monday, the dynamic image, the still image (Img1 (161) and ImgN (162)) are serially stored in the Mon directory 154, and so forth.

The first file directory group 163 inclusive of the Root directory 151 is recorded to only the partial DSA1 (114) corresponding to the partial SBM1 (110) shown in FIG. 6, the second file directory group 164 is recorded to only the partial DSA2 (115) corresponding to the partial SBM2 (111) shown in FIG. 6 and the third file directory group 165 is recorded to only the partial DSA3 (116) corresponding to the partial SBM3 (112) shown in FIG. 6.

As described above, because the monitor camera apparatus 101 of FIG. 6 to which the data management and control system according to the second embodiment of the invention is applied can dispersedly record the data to the semiconductor flush memory 106 in terms of the month unit or the year unit, the blocks in which the bit map is arranged can be used on an average, the service life of the semiconductor flush memory 106 can be extended and maintenance of the monitor camera apparatus 101 can be saved.

Because the change position of the block in the space bitmap 109 can be always limited to one partial SBM, the synchronization processing of the space bitmap 109 can be quickly completed. Because the time for the synchronization processing can be fixed, read/write of the monitor information acquired can be made from and to the semiconductor flush memory 106 at a constant bit rate.

The monitor information acquired from Monday to Tuesday is stored in the partial DSA1 (114) corresponding to the partial SBM1 (110), the monitor information acquired from Wednesday to Thursday, to the DSA2 (115) corresponding to the partial SBM2 (111), and the monitor information acquired from Friday to Sunday, to the partial DSA3 (116) corresponding to the partial SBM3 (112). Therefore, the access to the desired monitor information can be made at a high speed. The monitor camera apparatus as a concrete example of the semiconductor flush memory accommodation apparatus to which the data management and control system according to the second embodiment is applied has thus been explained.

The invention can be applied to various kinds of apparatuses using the semiconductor flush memory in which data can be erased in the block unit as a storage device and is effective as a technology for extending the service life of such a semiconductor flush memory and for easily reading/writing data having high real time property.

As explained above, the embodiment of the invention has the following construction as a concrete example. In other words, when a space bitmap recorded to a semiconductor flush memory is so arranged as to spread over three blocks in the semiconductor flush memory using a UDF file system as a file system, the invention provides a mapping rule such that a Root directory 11 is recorded to a partial DSA1 corresponding to a partial SBM1, a first file directory group 12 is recorded to only the partial DSA1 and a partial DSA2 corresponding to the partial SBM1 and a partial SBM2 and a second file directory group 13 is recorded only to the partial DSA1 and the partial DSA3 corresponding to the partial SBM1 and the partial SBM3.

It should be further understood by those skilled in the art that although the foregoing description has been made on embodiments of the invention, the invention is not limited thereto and various changes and modifications may be made without departing from the spirit of the invention and the scope of the appended claims.

1. A data management and control system in a semiconductor flush memory for executing data erasure in a block unit, wherein:
a data storage area for storing file data stipulated by a file system and a space bitmap representing a use condition of said data storage area and constituted by a plurality of partial space bitmaps in the block unit are formed in said semiconductor flush memory;
said partial space bitmaps correspond to partial data storage areas divided in said data storage area, respectively; and
a mapping rule for associating file directory groups so assorted as to correspond to the number of said partial space bitmaps with said partial data storage areas and having partial data storage areas to which one file directory group cannot be recorded in such a fashion as to spread over other storage areas is set.

2. A data management and control system according to claim 1, wherein said file system is based on a UDF file system specification.

3. A data management and control system according to claim 2, wherein said mapping rule contains a root directory in said file data when the number of said partial space bitmaps is N (N≧3), divides said file directories below said root directory into N file directory groups without allowing said file directories to overlap with one another, manages said root directory by a first partial space bitmap, manages an Mth (1<M<N) file directory group by the first and Mth partial space bitmaps and records said Mth file directory group to only the first and Mth partial data storage areas.

4. A data management and control system according to claim 2, wherein said mapping rule contains only once a root directory in said file data when the number of said partial space bitmaps is N (N≧2), divides said file directories below said root directory into N file directory groups without allowing said file directories to overlap with one another, manages said root directory by a first partial space bitmap, manages an Mth (1<M<N) file directory group by the Mth partial space bitmap and records said Mth file directory group to only the Mth partial data storage areas.

5. A semiconductor flush memory accommodation apparatus comprising:
a semiconductor flush memory forming a data storage area for storing file data stipulated by a file system, and a space bitmap representing a use condition of said data storage area and constituted by a plurality of partial space bitmaps in a block unit;
a system memory for storing information for a synchronization processing with said space bitmap to look up or change said space bitmap and temporarily storing file the data;
data management means containing a data arrangement management portion for associating file directory groups so assorted as to correspond to the number of said partial space bitmaps with said partial data storage areas and providing a mapping rule having partial data storage areas to which one file directory group cannot be recorded in such a fashion as to spread over other areas, and managing a UDF file system and the space bitmap; and
data control means for controlling a data flow between said system memory and said semiconductor flush memory.

6. A monitor camera apparatus comprising:
a semiconductor flush memory forming a data storage area for storing file data stipulated by a file system, and a space bitmap representing a use condition of said data storage area and constituted by a plurality of partial space bitmaps in a block unit;
a system memory for storing information for a synchronization processing with said space bitmap to look up or change said space bitmap and temporarily storing file the data;
data management means containing a data arrangement management portion for associating file directory groups so assorted as to correspond to the number of said partial space bitmaps with said partial data storage areas and providing a mapping rule having partial data storage areas to which one file directory group cannot be recorded in such a fashion as to spread over other areas, and managing a UDF file system and the space bitmap;
data control means for controlling a data flow between said system memory and said semiconductor flush memory;
image processing means for acquiring images or sound; and
network connection means for establishing connection with network connection means,
wherein said file directory group includes image information divided by a plurality of weekdays.

7. A data management and control method in a semiconductor flush memory for executing data erasure in a block unit, comprising the steps of:
forming a data storage area for storing file data stipulated by a file system and a space bitmap representing a use condition of said data storage area and constituted by a plurality of partial space bitmaps in the block unit for said semiconductor flush memory; and
setting a mapping rule for associating a directory structure of said file data with partial data storage areas divided by said data storage area;
wherein said mapping rule contains a root directory of said directory structure when the number of said partial space bitmaps is N (N≧3), and divides said file directories below said root directory into N file directory groups without allowing said file directories to overlap with one another, manages said root directory by a first partial space bitmap and executes recording to only a first partial data storage area corresponding to said partial space bitmap, manages an Mth (1<M<N) file directory group by the first and Mth partial space bitmaps and executes recording to the first and Mth partial data storage areas corresponding to said partial space bitmap; and
wherein said Mth file directory group cannot be recorded in such a fashion as to spread over Mth and Lth (L: an integer smaller than N with the exception of 1 and M) partial data storage areas.

8. A data management and control method in a semiconductor flush memory for executing data erasure in a block unit, comprising the steps of:
forming a data storage area for storing file data stipulated by a file system and a space bitmap representing a use condition of said data storage area and constituted by a plurality of partial space bitmaps in the block unit for said semiconductor flush memory; and
setting a mapping rule for stipulating association between a directory structure of said file data and partial data storage areas divided by said data storage area;
wherein said mapping rule contains only once a root directory of said directory structure when the number of said partial space bitmaps is N (N≧2), divides said file directories below said root directory into N file directory groups without allowing said file directories to overlap with one another, manages said root directory by a first partial space bitmap and executes recording to only a first partial data storage area corresponding to said partial space bitmap, manages an Mth (1<M<N) file directory group by an Mth partial space bitmaps and executes recording to only said Mth partial data storage area corresponding to said partial space bitmap; and
wherein said Mth file directory group cannot be recorded in such a fashion as to spread over other partial data storage areas than said Mth partial data storage area.
